(19) United States
(12) Patent Application Publication
(10) Pub. No.: US 2014/0252129 A1
(43) Pub. Date: Sep. 11, 2014

(54) DEVICE AND COMPOSITION FOR SPRAYING DRY PET FOOD WITH AN OIL, COMPOSITION CONTAINING OMEGA 3 COMPOUNDS OF SALMON OIL IN A SPRAY FOR PETS BASED ON BAG ON VALVE TECHNOLOGY

(71) Applicants: RODRIGO FERNANDO DURRUTY ORTEGA, SANTIAGO (CL); GONZALO FERNANDO ACUÑA FERRARI, SANTIAGO (CL); RODRIGO MAURICIO NUÑEZ LARA, SANTIAGO (CL)

(72) Inventors: RODRIGO FERNANDO DURRUTY ORTEGA, SANTIAGO (CL); GONZALO FERNANDO ACUÑA FERRARI, SANTIAGO (CL); RODRIGO MAURICIO NUÑEZ LARA, SANTIAGO (CL)

(21) Appl. No.: 14/196,318

(22) Filed: Mar. 4, 2014

Related U.S. Application Data
(60) Provisional application No. 61/772,557, filed on Mar. 5, 2013.

(51) Int. Cl. B65D 83/14; A23D 7/00

(52) U.S. Cl. CPC B65D 83/752; A23D 7/003
USPC 239/337; 554/224

(57) ABSTRACT

A device and composition for spraying on dry pet food, such as pellets, with an oil composition containing Omega 3 compounds, where the device uses an aerosol sprayer device of the bag on valve type, and the product to be sprayed, can combine different oils and pharmaceutical grade fish oils concentrates which contain Omega 3, improving the pellet pet food organoleptic characteristics, its taste and simplifying the administration to the pet of all the advantages the compound containing Omega 3, provides.

### CROSS REFERENCE TO RELATED APPLICATIONS

This application claims the benefit of U.S. Provisional application Ser. No. 61/772557 filed on Mar. 5, 2013.

### FIELD OF THE INVENTION

This invention relates to an improved device to spray dry pet food or pellets with an oil containing composition of Omega 3 suitable for minor pets, like dogs and cats.

### BACKGROUND

If an owner wants to administer oil containing Omega 3 nutritional supplement to his pets with a composition which is usually not included in normally marketed pet food, he or she usually would have to give the pet a soft capsule, which includes some practical problems when it is fed to the pet. Plus the oily composition usually makes the dry pet food sticky and unattractive to the pets. The present invention provides a spray which solves the problems associated with these and other devices in the related art.

### SUMMARY OF THE INVENTION

A device is provided which comprises an aerosol system that allows administering pets an oil composition which contains Omega 3 a strong nutritional supplement based on extra refined and deodorized fish oil enriched with Omega 3 EPA/DHA fatty acids, which provide pets with a healthier looking fur coat and a healthy skin, improves and supports the pet's joints, kidneys, heart function and contributes to the general health of the animal and improves its immune functions. Omega 3 fatty acids will help to produce healthy adults and longer living pets. Additionally the compound containing Omega 3 EPA/DHA improves the eating quality, flavor and appearance of the pellets enhances the organoleptic character adding a particular flavor which makes the pet food attractive to the animals.

### Problem it Solves

In the related art, supplements are supplied in the form of a soft capsule or by using a pump action dispenser. In the case of the soft capsule, it had to be administered to the pet directly into the muzzle, very often the capsule was given up, half chewed, which rendered it useless.

The second administering system was using a hand pump dispenser of the type used for dispensing liquid soap at home. This system had a great problem, which occurs when the compound is exposed to CO₂ or plainly to the atmosphere, when this occurred, the compound became rancid, producing variations of its color, the dispenser usually dripped after usage and it was determined that the storage fife of the compound was drastically shortened, from one year and up, to a maximum of eighteen months, was shortened to three months, rendering the product obsolete.

The advantages of the present invention are, among other, eighteen months shelf life before expiry, this is a notable extension of the shelf life of the oil oxidized, for which the shelf life was thirty days average. The product is easy to apply to the dry food, keeping it from becoming rancid, there is no dripping, plus it is ambient friendly as the use of a bag on valve spraying system avoids the contact of the composition with the air, plus the propellant has no contact with the compound and also any ambient friendly propellant can be used.

Another problem the present invention corrects is the dry pet food on which Omega 3 was added by hand pumping on it, the compound, the quantity sprayed was too much and it made the pellets to stick together and became soggy and unattractive to the pet, this is also solved by the present invention.

The above mentioned problems affected seriously the pet food market and specially the use of Omega 3 products as a nutritional supplement for pets for some time.

### BRIEF DESCRIPTION OF THE DRAWINGS

While the specification concludes with claims which particularly point out and distinctly claim the invention, it is believed that the present invention will be better understood with the following description of the preferred embodiments taken in conjunction with the accompanied drawings, in which like reference numbers identify identical elements and in which:

FIG. 1 is a cross-sectional view of a spray can according to an embodiment of the invention, in which an aerosol spray can of the bag on valve type is shown.

### DETAILED DESCRIPTION

While the specification concludes with claims which particularly point out and distinctly claim the invention it is believed the present invention will be better understood from the following description.

Several patents have been granted in reference to spray cans, we will mention U.S. 7,730,911, which is incorporated herein by reference, only as information to clarify the concepts of certain embodiments of the present specification.

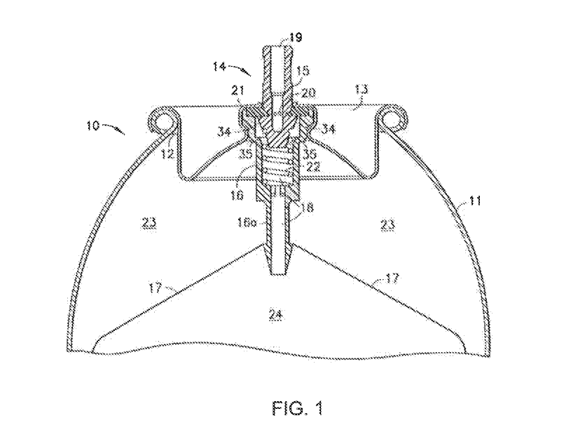

Referring to FIG. 1, aerosol valve system 10 includes a closed container or can 11 (only the top portion of which is shown) with a top circular opening 12 within which is mounted aerosol mounting cup 13. Centrally disposed within mounting cup 13 is aerosol valve 14 comprised of valve stem 15 and valve housing 16. Valve housing 16 at the extension 16a of its lower end has a flexible product or compound bag 17 attached thereto in a sealingly connected manner. Flexible bag 17 may be comprised of polyethylene and/or other materials (including in laminated form) and is of well known structure. Bag 17 will contain the compound to be dispensed from the aerosol container, and is a closed structure throughout except at the top of the bag where it is open only into the interior 18 of the valve housing. The bag 17 is welded all about its top opening to the outside of the lower extension 16a of the valve housing. The bag 17 alternatively may be welded to a wedge or other fixture at the end of lower extension 16a, Bag 17, only partially shown, extends down into the container to near the bottom of the container in known fashion.

As indicated the supplement administering system of the present invention uses aerosol containers of the barrier pack type include the well-known piston-in-can, and bag-in-valve, embodiments. In one form of the latter, to which the device of the present invention is designed in order to prevent the disadvantages of the previous art which chemically affected the compound contained in the spray cans, a flexible bag within the can may have its open end sealingly connected to the valve housing of the aerosol valve. Such embodiments are referred to as bag-on-valve systems. The product to be dispensed from the aerosol container commonly is filled and stored in the flexible bag within the container and a liquified propellant or compressed gas is filled into the aerosol container outside of the bag between the bag outer wall and the inner wall of the can, the spray, the oily Omega 3 compound never comes in contact with the propellant, which can be fluoro carbon or compressed air, with the mentioned advantages.

When the aerosol valve is actuated, the propellant acts against the outer wall of the bag to force the product being dispensed out the aerosol valve to the environment outside the can. When the valve actuation ceases, of course, the product dispensing ceases.

Having mentioned the general concept of the aerosol spray system used in the present invention, the following is a description of the embodiment which considers the compound which is sprayed by the bag on valve spray dispenser.

The compound to be sprayed, comprises Omega 3 contained in Pharmaceutical grade salmon oil concentrates and is prepared according to the process described as follows:

To manufacture 1 kg (4,54 pounds) of pharmaceutical-grade fish oil concentrate requires 100 kgs (454 pounds) of health food-grade fish oil like salmon oil, used in preparing this Omega 3. Producing pharmaceutical-grade fish oil concentrates requires state-of-the-art manufacturing capabilities to assure maximum EPA/DHA purity and concentration of long chain omega-3 fatty acids essential for eico-sanoid modulation.

Step 1 Extraction of fish oil,

Step 2 Winterization—remove limited amounts of saturated fats,

Step 3 Absorption—remove heavy metals,

Step 4 Preliminary Molecular Distillation—refining ‘touch up” to reduce pcb's and cholesterol,

Step 5 Oil conversion into ethyl esters,

Step 6 Ethyl Ester Thermal Fractionation—remove additional saturated fats,

Step 7 True Molecular Distillation—final refining to assure removal of all manmade pollutants such as pcb's and long-chain monoenes,

Step 8 Pharmaceutical-grade fish oil concentrates,

Step 9 Quality Control—prior to packaging Omega 3 pharmaceutical-grade fish oil concentrates are subject to rigorous analysis and are certified by an Independent Laboratory for final certification before product formulation.

This product is guaranteed to meet or exceed the Omega 3 compounds specifications.

Another embodiment for the preparation of Omega 3 is described as follows:

An Elsevier paper on Innovative food science & Emerging technologies (Vol 11 issue 1, Jan 2010, pages 1-12) describes Omega-3 polyunsaturated fatty acids are being used quite extensively in the food industry to obtain omega-3 enriched food products.

Most of the commercial concentrates that can be founc nowadays are the omega-3 ethyl ester derivatives. However, research is ongoing to obtain the more natural and better digestible triglyceride concentrates.

The following is a review of the most recent advances, regarding the production of omega-3 concentrates from the very first raw material that contains them from which they should be extracted to the omega-3 concentrates stabilization. In between, a good number of different technologies that are being industrially applied, or still under investigation, are reviewed, One of the technologies with high expectation is supercritical fluid technology, and it finds a relevant place in the review here presented.

Industries involved on innovation, require rapid overviews of the different possibilities open for production, and in that sense, the above review is expected to be of interest to an important portion of the pet food market.

1. A device comprising an aerosol spray can which sprays a composition comprising Omega 3 as a nutritional supplement on dry pet food pets like dogs and cats.

2. The device according to claim 1, wherein said aerosol spray can is of the bag on valve type.

3. The device according to claim 2, wherein the bag on valve spray can prevents the contact of the composition comprising Omega 3 to contact the propellant.

4. The device according to claim 2, wherein the bag on valve spray can prevents the contact of the propellant to contact the composition thus preventing the oxidation of the composition.

5. The device according to claim 2, wherein the bag on valve spray prevents the oxidation of the composition produced by its exposure to CO₂ and/or atmospheric air and prevents the rancifying of the Omega 3 contained in the composition thus shortening its shelf life drastically from a year and a half to three months.

6. The composition according to claim 5, wherein said composition which is to be sprayed by the device comprises Omega 3 EPA/DHA contained in fish oil.

7. The composition according to claim 5, wherein said fish oil contained in said composition is obtained from pharmaceutical grade salmon oil concentrates Omega 3 EPA/DHA.

8. The composition according to claim 5, wherein said Omega 3 EPA/DHA is prepared according to the following procedure;
Step 1 Extraction of fish oil,
Step 2 Winterization—remove limited amounts of saturated fats,
Step 3 Absorption—remove heavy metals,
Step 4 Preliminary Molecular Distillation—refining ‘touch up” to reduce pcb's and cholesterol,
Step 5 Oil conversion into ethyl esters,
Step 6 Ethyl Ester Thermal Fractionation—remove additional saturated fats,
Step 7 True Molecular Distillation—final refining to assure removal of all manmade pollutants such as pcb's and long-chain monoenes,
Step 8 Pharmaceutical-grade fish oil concentrates,
Step 9 Quality Control—prior to packaging Omega 3 pharmaceutical-grade fish oil concentrates are subject to rigorous analysis and are certified by an Independent Laboratory for final certification before product formulation. This product is guaranteed to meet or exceed the Omega 3 compounds.

9. The composition according to claim 8, wherein said Omega 3 EPA/DHA obtained is of EPA/DHA maximum purity and concentration of long chain omega 3 fatty acids essential for eicosanoid modulation.
